(19) United States
(12) Patent Application Publication
(10) Pub. No.: US 2024/0022581 A1
(43) Pub. Date: Jan. 18, 2024

(54) CONTINUOUS ACTIVE DEFENSE FOR DIGITAL SERVICES

(71) Applicant: FEEDZAI - CONSULTADORIA E INOVAÇÃO TECNOLÓGICA, S.A., COIMBRA (PT)

(72) Inventors: JOSE CARLOS CORRALES CASAS, Coimbra (PT); DAVID MORÁN ANTÓN, Coimbra (PT); GUILLERMO ALCOJOR DEL SASTRE, Coimbra (PT); JAVIER LIÉBANA DE LA BARRERA, Coimbra (PT); FERRAN PLA FERNÁNDEZ, Coimbra (PT); ROBERTO ADDELKADE MARTÍNEZ PÉREZ, Coimbra (PT); JOÃO TIAGO BARRIGA NEGRA ASCENSÃO, Coimbra (PT)

(21) Appl. No.: 18/345,626

(22) Filed: Jun. 30, 2023

(30) Foreign Application Priority Data
Jul. 1, 2022 (PT) 118078

(51) Int. Cl. H04L 9/40

(52) U.S. Cl. CPC H04L 63/1416; H04L 63/1425; H04L 63/20; H04L 63/0876

(57) ABSTRACT

A method and system for securing an online client-server session between a client device and a server device by application of at least a countermeasure, comprising the server device collecting client behavior pattern during the online session, the server device marking the online session as an affected session according to a pre-agreed client-server protocol, independently of any server-client contact, the client device requesting a client-initiated countermeasure according to the pre-agreed client-server protocol, the server device responding with an indication of a particular countermeasure to be carried out by the client device, the client device carrying out the indicated particular countermeasure and sending to the server device a reaction to the countermeasure, and the server device verifying the client reaction to the countermeasure, and if verified, marking the online session as non-affected.

This application claims the benefit of priority under 35 U.S.C. § 119(e) from Portugal Patent Application No. 118078, filed on Jul. 1, 2022, which is hereby incorporated by reference as if set forth in its entirety herein.

### TECHNICAL FIELD

The present disclosure relates to a method and system for securing an online client-server session between a client device and a server device by application of at least a client-initiated countermeasure and to actively capturing the reactions to such countermeasure.

### BACKGROUND

Electronic devices have become ubiquitous in recent decades. Moreover, the widespread availability of mobile Internet connections is transforming our daily lifestyle. Nowadays, businesses, organizations, and government agencies increasingly offer services digitally, rather than (or in complement of) physically. Our society has rapidly adopted these technologies, and customers expect to be able to access services from anywhere, anytime.

The digital world is not untouched by possible malicious actors, as fraudsters aim to exploit digital systems. As digital services increase in popularity, so does digital fraud. Feedzai's recent Financial Crime Report [1], based on over 18 billion transactions, indicates a 233% increase in fraud attacks from 2019 to 2021. At the same time, it is observed a 75% decrease in US cash withdrawals comparing 2019 to 2021, showing the relevance of the digital activities relative to physical alternatives.

Additionally, the availability of devices able to access these services is increasing. For instance, the average American has access to more than ten connected devices in their households. As a result, the attack surface, defined as the number of attack vectors available to malicious actors, is also increasing.

These combined factors lead to the proliferation of different defense systems. Their ultimate goal is to ensure the availability and security of digital services, fostering access and convenience to legitimate users while protecting them, to the highest degree possible, from malicious actors.

The existing defense systems focus on silently analyzing risks while users perform their everyday actions. These systems are active if able to deploy countermeasures to prevent illicit actions. Once they detect certain risk factors, such as anomalous behavior or other fraud indicators, most active systems blindly apply a countermeasure, namely disconnecting the user. Depending on other security settings, attackers can bypass it by reconnecting, particularly without robust security measures such as multi-factor authentication (MFA). Moreover, even if the countermeasure is successful, it is not exempt from a negative impact for those wrongly classified users. The action of inadvertently disconnecting a legitimate user or blocking their access has a significant impact on trust, perception of security, and, ultimately, customer satisfaction.

To counterbalance these attacks there are several systems that leverage countermeasures, namely for fraud prevention in electronic devices.

Ideally, fraud should be prevented rather than detected. As authors of [2] define, fraud prevention systems use mechanisms to avert fraud altogether.

The authors of [3] classify these systems under two major categories: non-technical tools and technical tools. The former tools do not involve technology, and the authors propose two significant groups: legislative tools and training and education tools. Legislative tools involve governmental regulations over electronic activities and cybercrime. However, as the authors also mention, these solutions are often inefficient, as pursuing the offenders is complicated. Alternatively, training and education tools empower individuals with knowledge and guidance. The authors consider this the essential factor in defending against cyberattacks, although limitations exist, such as engagement or the quality of the educational materials.

The other major category for fraud prevention tools is technological tools. The authors of [3] propose two major categories for these methods: blacklist methods and heuristic methods. The first approach proposes preventing attacks based on prior suspicious instances of a given element, such as blocking IP addresses previously associated with cyberattacks. Heuristics employ specific criteria to analyze the observed behavior, such as blocking an email as spam based on specific keywords.

Fraud prevention systems must be broad and general to cover as many fraud scenarios as possible. However, as the authors [2] report, these systems are not always enough and may occasionally be breached.

Fraud detection systems, as defined in [2], provide a second layer of defense after fraud prevention systems. These systems usually monitor the system to identify fraudulent activities and report them to an administrator. The authors identify two main categories of fraud detection systems: anomaly-based and misuse-based.

Anomaly-based fraud detection leverages the user's behavior as a mechanism for fraud detection. If there are significant deviations from the standard behavior, an alert is triggered to report a suspicious situation. In their study, the authors review several articles proposing different anomaly-based implementations.

Misuse-based fraud detection takes a different path: the fraudulent behaviors are pre-specified (e.g., using a rule-based system), and any other behaviors are considered legitimate. This approach is highly targeted but requires experience and expert knowledge. Its main limitation is its inability to detect new or unknown illicit patterns.

In particular, these prevention and detection mechanisms are not proactive in applying mitigation and remediation strategies as countermeasures.

Access control systems are mechanisms for restricting access to valuable resources or assets, as defined in [4]. These systems share some parallels with the proposed approach, as they must decide whether or not to grant access based on user information. The countermeasure, however, is chiefly limited to blocking the access completely. Also, these systems primarily focus on the moment of the access.

Another set of systems are the risk-based authentication systems. As described in [4], these systems are dynamic, as they adapt the access considering the situation at hand and its risk assessment. The main differentiate factor of these systems is the risk evaluation and some limited capability to decide the adequate countermeasures to apply. In particular, the authors propose a system that can balance security and accessibility. This article is one of the first ones proposing the evaluation of the environment and the current situation to decide on access to the information, in contrast with previous proposals that were static and indifferent to the context.

Similarly, in [5] the authors propose the usage of fuzzy logic to establish the rules for access control, i.e., to allow or deny the access. One of the main remarks from the authors is the importance of the flexibility of this approach. The authors of [6] proposed an abstract framework for this risk-adaptive access control models. In particular, the authors present a formal framework and the interactions of these systems.

A critical aspect of the risk-based authentication systems is the definition and assessment of the risk. In [7] the authors explore a strategy for risk assessment. Notably, they balance trust in the user with the risk of the resource. The decision is later reassessed based on the resulting outcome, increasing or decreasing the trust in the user and improving the system over time. In [8] the authors go beyond risk assessment and also aim to quantify possible benefits.

Specific studies are data-centric and focus on the data requirements to calculate the risk. For instance, the authors of [9] propose a combination of mouse movements and keystrokes dynamics as a source for the risk estimation. The authors claim that biometrical information is harder to spoof and propose it as a more robust solution.

Other works study adaptability. In [10], the authors present an adaptive self-framework for risk based authentication. The main contribution is the proposal of a system that adjusts itself. When an anomaly is detected, it can decide whether to adapt the access. This decision may trigger the enforcement of extra authentication factors, for example. Similarly, in [11] the authors introduce a system that evaluates the authentication. Suppose this authentication has been unsuccessful, or it has some indication of being suspicious. In that case, the system may trigger a second-factor authentication to verify the user's identity. This study presents a more advanced countermeasure beyond the denial of the service. However, it is limited to the authentication moment and it leaves open how to decide whether to apply this countermeasure and implementation considerations.

The adaptability of the countermeasures also deserves attention. The authors of [12] propose a dynamic system that selects the countermeasures automatically based on the decisions of a genetic algorithm. The main disadvantage of this approach is the lack of user or client control. It also focuses solely on the authentication requests, leaving undefended any other step of the user journey. Finally, it requires the user to set the effectiveness of each countermeasure against each attack. Thus, the scope is limited to already known and familiar attacks that may happen during the authentication process.

In [13] the proposal is to use an external model to adapt the security controls to different risk scenarios. The authors propose an architecture that measures the risk and passes this information to an adaptation layer. Based on the measurements, it adapts the security policies and sends them to a final layer that applies the changes. This proposal follows the measure-decision-adaptation schema. The authors propose using a flexible engine of rules and policies. However, this approach presents some limitations. First of all, it requires measurable metrics to evaluate the performance. Second, it is limited to a specific implementation. Finally, they propose an external agent and, therefore, the agent cannot apply countermeasures directly.

Finally, in regard to usage, the authors of [14] evaluate the functioning of these systems in different technology companies, such as Google, Amazon or Facebook, to determine the most relevant features they use and what range of variation they allow. The authors conclude that the most relevant feature is the common use of Internet Protocol (“IP”) in the study, but the available set of features they investigate is limited.

Most risk-based authentication systems provide the countermeasure of disconnecting the end user or stopping the current session, with just a few exceptions asking for re-authentication. Most of the work focuses on risk assessment but leaves open the application and implementation of possible countermeasures.

Whereas access control systems focus on access to particular assets, intrusion detection systems, as defined by [15], are broader as they cover the detection of any attack on the system.

The authors of [15] divide these systems based on detection method, behavior on detection, and audit capabilities. Detection methods can leverage the user's behavior or other types of information, such as the user's IP. The behavior on detection concerns what to do in the case of intrusion detection. It can be passive if it does not deploy mitigation actions or active if it does. In the context of this work, the audit capabilities mainly relate to whether the systems are distributed or centralized. The authors do not mention specific implementations or countermeasures.

One of the most referenced intrusion detection systems is the SPARTA framework presented in [16] that provides threat modeling and user-defined countermeasures. Its main functionality is pattern matching to detect threats. Once there is a match, there is the execution of a risk assessment and application of the defined countermeasure. Ultimately, SPARTA leaves the implementation, the risk evaluation, and the impact of each countermeasure to the user.

Other countermeasures are known, for example, the authors of [17] propose a list of high-level countermeasures and recommendations for a variety of cyberattacks. In [18], the authors also define and cover the most common cyberattacks, and for each of those, they suggest countermeasures that could be applied. These proposals mainly tackle prevention and do not focus as much on remediation or termination of the attack. Also, these countermeasures are set and forget, as there is no further evaluation of their impact.

In regard to particular countermeasures, [19] introduce the idea of challenges to present to the user to prevent account take over (ATO) attacks. The triggers are undefined, but the authors mention that once the user is deemed suspicious, the system may present the user with a second verification step: presenting proof of access to a device, proof of access to a backup account, or proof of access to a backup account knowledge of a shared secret. The authors present four main challenge categories: device-based, delegation-based challenges, knowledge-based challenges, and resource-based challenges. They performed multiple experiments and concluded in favor of device based challenges. However, the authors do not specify how to process, evaluate or react to the user's response to the challenge.

The authors of [20] show the functioning of a second factor authentication mechanism for mobile payments, and the threats that can affect to this schema. This study shows an interesting aspect: it proves that even a countermeasure such as a second factor authentication can be attacked. This second channel is not immune to possible attacks. This study shows the importance to have the adequate countermeasures for the specific use case, and also proves that the circumstances around the interaction of a countermeasure should be valued.

In [21] the proposal is an active system to prevent phishing attacks. They define and categorize possible attack variants and propose active countermeasures. The most relevant ones are triggering second-factor authentication, email authentication, and passive strategies such as SSL encryption or anti-phishing toolbars for the browser. However, the study does not cover how to trigger or apply countermeasures applied. It also does not mention any possible interaction or connection between the end-user reaction to the execution of the countermeasure and any possible further decision.

The authors of [22] present a system for network traffic analysis to monitor threats. They propose the inspection of network packages to evaluate the risk of suffering a cyberattack. Similarly, [23] proposes a risk-based system to prevent cyberattacks. In this patent, the authors mention the usage of a honey-pot subsystem as bait for the attackers to monitor the possible cyberattacks. Once detected a threat after automatic testing in case of a positive outcome, the system reports the case for further analysis. Both systems cannot apply countermeasures.

Other systems focus on the usage of previously known risks, such as the system described in [24]. This system detects threats in the communication between two computers. In this proposal, they assess the risk based on the reputation of the IP address. The system provides a simple countermeasure: to inhibit the connection to stop the communication.

Similarly, the authors of [25] propose a system that, based on the reputation of a specific website, may block the HTTP connection. The main objective of this system is to prevent the user from accessing phishing websites. They detect which servers are malicious, and as a countermeasure, they block the outgoing connections to those servers. To detect these risky servers, they propose setting up a honey pot. This approach, again, is limited to blocking access as the only countermeasure available to the system.

The authors of [26] present a system for fraud prevention. They introduced a countermeasure system for fraud committed with fraudulent checks. The merchant receives a check, sends it to the financial institution to assess the risk, and in case of being suspicious, it applies the appropriate countermeasures. These countermeasures range from calling the check writer to assure legitimacy to closing the account. The relevance of this approach resides in the fact that the system evaluates and applies adequate countermeasures based on the circumstances. Nevertheless, this approach has a minimal scope, and it requires manual steps such as the evaluation of the check or the contact with the customer.

Other solutions specialize in mobile devices. In [27], the authors describe a method to apply countermeasures in case someone is performing unauthorized access to a device. The system creates a model of the user's behavior to check for anomalies. If an anomaly is detected, it triggers a countermeasure. The countermeasures are not specified, nor the context in which they apply.

The work in [28] presents a more granular approach concerning countermeasures. The authors define a process of identifying different assets of a computing system. The user can define which countermeasure should be applied to which asset for a specific vulnerability. In the document, the authors mention using a risk engine to determine when these countermeasures should be triggered, but they do not specify how it works. The main limitation of this approach is that it requires a definition of countermeasure per device, specifying which threats to mitigate, and therefore, being valid only for known vulnerabilities. Also, they consider the application of the immediate countermeasure to the end goal without considering further reactions of the user.

The authors of [29] present a robust system for device identification. The system uses security tokens: the device that needs to access a resource sends the request with a security token. Based on the level of trust in the specific token, the system may decide to apply some countermeasures to reduce the risk of interacting with the protected resource.

Focusing on the selection of countermeasures, the authors of [30] show a system able to balance the perceived risk with the potential impact of large scale cyberattacks. The system is able to identify all resources exposed to possible cyberattacks and calculates the risk of those resources being attacked. At the same time, the system selects the best countermeasure based on the cost of applying that countermeasure compared versus the resource risk. For calculating the cost of the employment of the countermeasure, the system simulates its application and quantifies its impact. This system offers the novelty of simulating the cost, however, this approach is only valid for those cases where the impact of the countermeasure can be estimated beforehand. Also, the authors do not consider the possibility of applying more than one countermeasure or the reactions to the applied countermeasures.

The authors of [31] introduce a system that triggers the countermeasure once there is a deviation from the expected behavior. There is a stage of data collection in their system to create user profiles. Once there is a noticeable deviation from this norm, the system generates a response, ranging from blocking the user's access to alerting a system administrator. However, as with other approaches, the application of the countermeasure is the end goal, without considering the reactions after that countermeasure.

Most of the literature focuses on the decision part of the system. However, many of these studies lack details about active protection: the application of countermeasures to prevent or mitigate attacks. Often there is no in-depth explanation of the available countermeasures and when to apply them. Often, the one countermeasure provided is denying access. Moreover, the possibility of applying more than one countermeasure, either in parallel or sequentially, is typically not considered.

In summary, electronic activities are increasing thanks to the ubiquity of computational devices as well as the general and broad access to the Internet. These innovations have opened the doors to the access of services that previously were only available in the physical world. However, this has also brought the opportunity for malicious actors to illegitimately benefit from these digital services.

As a response to this fraudulent threat, different existing defense systems have been presented herein, and how they do not exploit all their potential, as they often limit themselves to disconnecting the user whenever there is a risk suspicion. This decision, if effective from the point of view of stopping the commitment of the fraud, carries the costly side effect of impacting to the usage of those non fraudulent users that may be misclassified by the system. These errors may cause a considerable damage to the user trust on this digital services.

These facts are disclosed in order to illustrate the technical problem addressed by the present disclosure.

### GENERAL DESCRIPTION

This document presents a Continuous Active Defense method and system for applying one or more countermeasures, and to actively capturing the reactions to these countermeasures, for online session security.

In an embodiment, a loop captures the reactions and uses them as a new source of information. This feature opens a new path of interacting with the user, retrieving feedback immediately while actively protecting the defended assets. This allows for better-informed decisions, which lead to more adequate countermeasures.

A continuous active defense system capable of applying countermeasures and closing a loop by capturing the end user's reactions. The countermeasures are not limited to protecting the system but also actively gathering information, enabling more granular, better countermeasures.

The present document discloses a method for securing an online client-server session between a client device and a server device by application of at least a countermeasure comprising a predetermined session-security challenge-response pair, the method comprising the steps of: the server device collecting client behavior pattern during the online session; the server device marking the online session as an affected session according to a pre-agreed client-server protocol, i.e. independently of any server-client contact, e.g., triggering a particular trigger condition by the server device based on at least in part the collected client behavior pattern during the online session; the client device requesting a client-initiated countermeasure according to the pre-agreed client-server protocol, i.e. independently of any server-client contact; i.e. these actions of marking and requesting countermeasure are asynchronous, the server device responding with an indication of a particular countermeasure to be carried out by the client device; the client device carrying out the indicated particular countermeasure and sending to the server device a reaction to the countermeasure; and, the server device verifying the client reaction to the countermeasure, and if verified, marking the online session as non-affected.

In an embodiment, the method further comprising the steps of: if the client reaction to a countermeasure is not verified, the client device requesting an additional client-initiated countermeasure according to the pre-agreed client-server protocol; the server device responding with an indication of a particular additional countermeasure to be carried out by the client device; the client device carrying out the indicated particular additional countermeasure and sending to the server device a reaction to the additional countermeasure; and, the server device verifying the client reaction to the additional countermeasure, and if verified, marking the online session as non-affected, i.e., the method for carrying out additional countermeasures can be repeated.

In an embodiment, the pre-agreed client-server protocol comprises triggering the steps of marking and requesting a countermeasure when: a particular client behavior pattern occurs during the online session; and/or a periodic time period occurs during the online session.

In an embodiment, the client behavior pattern includes at least one selection from the group consisting of: an estimated security risk above a predetermined threshold, in particular an estimated risk of illicit account takeover above a predetermined threshold; a particular device characteristic or characteristics; a particular user journey; a particular user interaction; a particular set of user interactions; and a lack of a particular user interaction.

In an embodiment, the client device requesting a client-initiated countermeasure according to the pre-agreed client-server protocol is synchronized with predetermined online session events, in particular the predetermined online session events comprising login of the online session, window focus loss of the online session, or combinations thereof.

In an embodiment, the particular countermeasure to be carried out by the client device is selected from a list comprising: blackening screen capture by adjusting screen capture permissions; completing a challenge response, in particular comprising text-completion challenge, mouse movement challenge and/or image classification challenge; carrying out a two-factor authentication challenge; and logging out the online session, typically followed by logging-in if the user is legitimate.

In an embodiment, the online client-server session is pre-authenticated.

In an embodiment, the server device marks the online session as an affected session according to a pre-agreed client-server protocol, without sending an indication of the affected status to the client.

In an embodiment, the online session is a client-server web session and the client device runs a web browser arranged to carry out the client device side of the method.

In an embodiment, the server-device is arranged to serve a web page comprising computer program instructions that when run on the client device cause it to carry out the client device side of the method.

In an embodiment, the online session is a client-server application session and the client device runs an application comprising an application library arranged to carry out the client device side of the method.

In an embodiment, an indication of sessions marked as affected are stored in a dynamic cache with a time-limited read period, or in a queue, or in a database.

In an embodiment, the method further comprising providing a countermeasure service for the server device to respond with an indication of a particular countermeasure or countermeasures to be carried out by the client device, wherein said countermeasure service is a client-initiated polling service.

In an embodiment, a session marked as affected has a corresponding countermeasure or countermeasures stored in a countermeasure database.

In an embodiment, the countermeasure or countermeasures available for a session marked as affected are determined by one or more triggers at the server device when the online session is marked as an affected session according to the pre-agreed client-server protocol.

In an embodiment, one or more triggers are contained in a rule database where, for each rule, a corresponding countermeasure is enabled or disabled according to a predetermined condition or conditions.

In an embodiment, communications between server device and client device are encrypted.

It is further disclosed a non-transitory computer-readable medium comprising computer program instructions for securing an online client-server session between a client device and a server device, which when executed by a processor, cause the processor to carry out any of the described methods.

It is also disclosed, a computer system comprising the previously described computer-readable medium.

It is further disclosed, a system comprising a client device and a server device, for securing an online client-server session between the client device and the server device by application of at least a countermeasure comprising a predetermined session-security challenge-response pair, the system being arranged to carry out the steps of: the server device collecting client behavior pattern during the online session; the server device marking the online session as an affected session according to a pre-agreed client-server protocol, i.e. independently of any server-client contact; the client device requesting a client-initiated countermeasure according to the pre-agreed client-server protocol, i.e. independently of any server-client contact; i.e. these actions of marking and requesting countermeasure are asynchronous, the server device responding with an indication of a particular countermeasure to be carried out by the client device; the client device carrying out the indicated particular countermeasure and sending to the server device a reaction to the countermeasure; and, the server device verifying the client reaction to the countermeasure, and if verified, marking the online session as non-affected.

### BRIEF DESCRIPTION OF THE DRAWINGS

The following figures illustrate embodiments consistent with the disclosure and should not be seen as limiting the scope of invention.

FIG. 1: is a representation of an embodiment of a system for securing an online connection.

FIG. 2: is a schematic representation of an embodiment of a system's architecture for securing an online connection.

FIG. 3A: is a schematic representation of an embodiment of a remote access tool protection.

FIG. 3B: is a schematic representation of the embodiment of FIG. 3A, now showing the the client device requesting countermeasures before authorizing a transfer.

### DETAILED DESCRIPTION

Instead of blindly disconnecting the user, herein it is disclosed a method, and respective system, that actively takes advantage of multiple countermeasures.

Briefly, as will be appreciated, systems and methods consistent with this disclosure can be performed by software or firmware in machine readable form on a tangible (e.g., non-transitory) storage medium. For example, the software or firmware can be in the form of a computer program including computer program code adapted to cause the system to perform the monitoring and various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously. The code utilized by one or more embodiments of the present invention comprise instructions that control the processor to execute methods, such as detailed hereinbelow. The instructions can comprise a program, a component, a single module, or a plurality of modules that operate in cooperation with one another. More generally, the code comprises a portion of an embodiment implemented as software. The component(s) or module(s) that comprise a software embodiment can include anything that can be executed by a computer such as, for example, compiled code, binary machine level instructions, assembly code, source level code, scripts, function calls, library routines, and the like. In other embodiments, the code can be implemented in firmware or a hardware arrangement.

In an embodiment, a reactive system is proposed that adapts to the sequential nature of attacks and countermeasures in adversarial settings, such as digital fraud. Whenever the system deploys a countermeasure, there is a reaction from the user's device. For example, if an anomalous location for the user's connection is detected, the system triggers some silent countermeasure to identify the device. With the response, the system would analyze if the device is legitimate. The system includes memory that stores instructions and other information and a hardware processor that executes such instructions, such as to trigger one or more silent countermeasures. The memory and processor can be part of a server of conventional design. If the response still presents uncertainty, the system could require a more intrusive countermeasure, such as, for example, asking the user to type a code in a text box by executing further instructions in the processor. The user would react by performing the required keystrokes. These keystrokes, however, contain information about the active user, such as typing patterns, that can be captured and used by the system to inform better risk assessments, resolving the previous uncertainties.

Hereby, the digital defense is framed as a sequential game, more akin to chess, Go, or turn-based strategy games, and not as a simultaneous one, where players select strategies without knowledge about other players' actions, such as, to give an illustrative example, rock-paper-scissors.

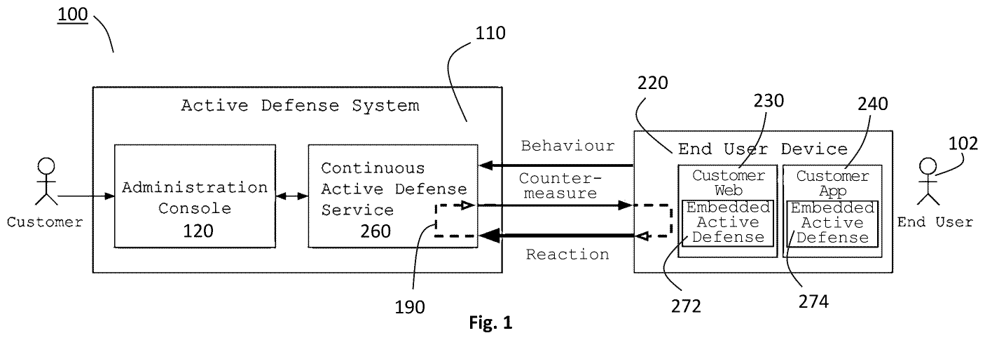

The proposed system captures in real time the reactions to the deployed countermeasures to perform better decisions at each round. The continuous active defense loop consists of deploying a countermeasure, capturing and analyzing the user device's response, and deciding if and how to counter. The loop 190 is illustrated in the schematic of FIG. 1, extending between the end user device 220 to the active defense system 110. To be clear, the capture, analysis, decisions and deployment of countermeasures are among the various actions taken by the system under control of a processor executing suitable code.

FIG. 1 shows a diagram representation of an embodiment of a system 100 for securing an online connection.

In an embodiment, the system stores in memory, a database, or both and uses these reactions and the collected behavior to improve the accuracy of an intelligence component 268 in real time. In an embodiment, the system 100 can be implemented as rules based on expert knowledge and adapted over time with this information, which rules and knowledge are stored and made available to the code executing in the processor. In another embodiment, the system 100 is implemented as a machine learning model based on the historical data about collected behavior, applied countermeasures, and observed reactions, all of which is stored and made available to a suitably programmed processor for implementing these actions. Using the countermeasure reactions as part of the intelligence data is a differentiating factor, as it boosts the real time adaptability of the disclosed approach.

The proposed system enables continuous real time action-response interaction between users and digital defenses while collecting more data about users, attack patterns, and the effectiveness of different countermeasures in specific contexts.

The presented embodiments are particularly important, not only in financial fraud but also in other cybersecurity areas, such as network protection or intrusion detection.

The disclosed Continuous Active Defense thus comprises a system to evaluate the risk of a user's session and trigger adequate, client-defined countermeasures. Once the system deploys a countermeasure, the processor is configured by further code to analyze the observed reaction and decide what further actions to apply, if any.

Consider an end-user 102 of certain digital services. For instance, in the case of digital banking, the end-user would have credentials to access the bank's website or mobile application. The user may use its credentials to access the account and perform different actions, such as checking the balance, modifying personal information, or doing transfers and payments. The risk, however, is that, somehow, the user may be compromised.

In an embodiment, the Continuous Active Defense method and system 110 integrates with websites or dedicated applications to offer continuous protection across the user journey so that users can benefit from the convenience of digital services without compromising security.

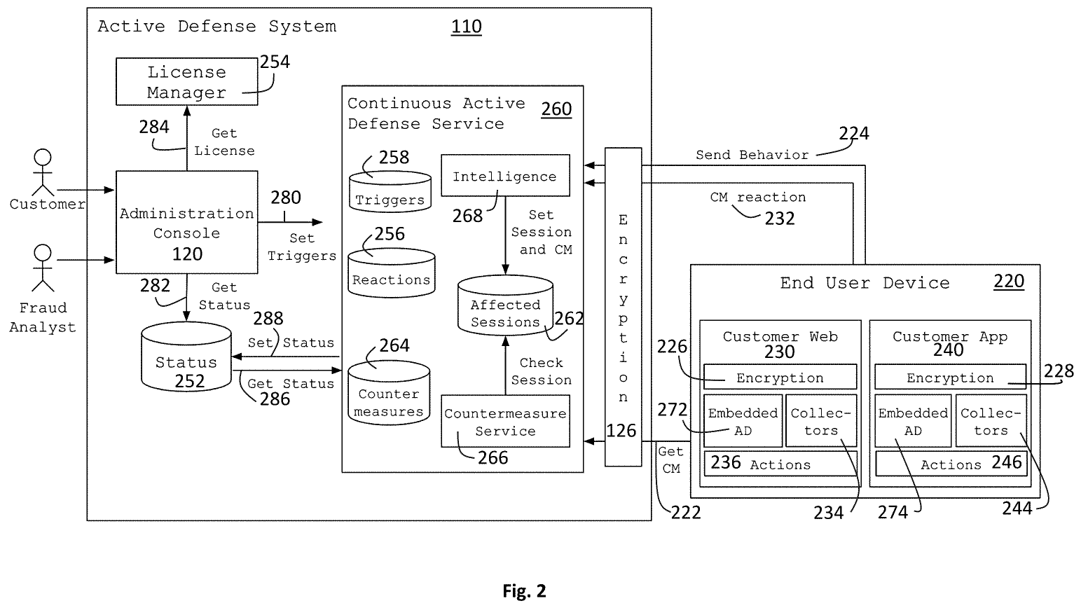

FIG. 2 shows a schematic representation of an embodiment of a system's architecture for securing an online connection.

In an embodiment, the Active Defense components in the end-user device 220 capture relevant actions and send them to the system 110 for analysis. The device 220 also requests countermeasures 222 for the active session. All communication between the device 220 and the system 110 is preferably encrypted by encryption modules 226, 228, 126, each of which comprises code executing within a processor, ensuring user privacy and data integrity.

The device 220 sends in real time the data including behavior data 224 to the system. The device 220 is also responsible for calling (requesting) the system to pull the countermeasures. The pull model integrates the disclosed method and system within the normal functioning of the digital service without unnecessary disruptions or friction while optimizing the available resources. Moreover, the device has the appropriate context to decide when to request countermeasures 222. For instance, the risk may be higher when a user is accessing a payment view or changing personal details. These actions may warrant a check to understand what countermeasures should be applied, if any, to ensure security.

The disclosed method and system 110 is responsible for decrypting and evaluating incoming data against a set of policies that may include, among others, blocklists, rules, or machine learning models. These policies aim to estimate the risk of the active session based on the observed user and device behavior and decide what countermeasures to apply.

The policies are customer-defined and managed through the Administration Console 120, including Triggers and Countermeasures. The console, in some embodiments, also access the system's Status 252. The License Manager 254 manages access privileges. The console 120 and the license manager 254 each can comprise a computer or a server having at least a processor and memory, and in some implementations a respective hardware processor.

In an embodiment, a continuous active defense service (“CADS”) 260 operates as part of the active defense system 110 once the active defense system 110 decides on a countermeasure, using code executing in its processor(s), it does not apply it immediately, for that would ignore the current context of the session. In fact, at that moment, the user's device 220 is unaware of the countermeasure. Instead, the system places the session and the corresponding countermeasure in a list of Affected Sessions 262. The device should pull countermeasures stored in a countermeasure database 264 using a countermeasure service 266 whenever necessary by querying the system. The pull model decouples decision-making from executing the countermeasures, ensuring independence and the ability to scale separately.

The end user device 220 executes the necessary actions if countermeasures exist and collects the response either from browsing a website 230 or from end-user apps 240, using collectors 234, 244, respectively. The response 232 provided by the end user device 220 to the CADS 260 informs the re-evaluation of the risk and, when applicable, additional countermeasures to be provided to the end user device. The ability to collect and operate on user reactions 232 to applied countermeasures enables the creation of an action-reaction feedback loop. Notably, it allows for dynamic, multi-step defense strategies and increased interactivity with the user 102. It also allows for more informed decision-making, as user reactions constitute important data points to assess the session's risk. Moreover, the record of countermeasures and responses may contribute to defining better risk policies in the future.

Digital service providers may embed the disclosed method and system in their websites 230 or dedicated applications 240.

In regard to the Customer Website, the customer offers digital services to the user through a website 230 accessed from the end user device 220. Typically, the user accesses the digital services through a web browser. The customer may integrate the disclosed method and system code, usually JavaScript, in relevant web pages. The browser can run it locally and communicate with the disclosed method and system whenever necessary, assuming a functional Internet connection.

The sequence of user actions 236 while browsing the website, from the first arrival to, eventually, stopping using it (e.g., by going to another website or inactivity), constitutes a session. Through the web browser, the device 220 pulls 222 and executes countermeasures from the disclosed method and system throughout the session. The user behavior 232 during the session informs the countermeasure service 266.

A dedicated application 240, commonly referred to as an app, is a type of software that runs on mobile devices, such as smartphones or tablets. In a particular embodiment, the app 240 directly integrates the Embedded components of the disclosed method and system, including encryption 228, collectors 244 and actions 246, typically through a Software Development Kit (SDK) that packages all the necessary components and functionality.

Customer apps 240 allow direct interaction with the disclosed method and system and are not subject to the capabilities and constraints of a web browser environment. Instead, the operating system (OS), such as Android or iOS, provides the framework.

As in a web session, an application session corresponds to all user actions while using the app, from arrival to departure (e.g., closing the app, executing a task) or inactivity.

The device 220 collects and sends user actions to the Active Defense System 110, including biometrics (e.g., clicks, keystrokes, or mouse movements), behavior (e.g., user journey), and device information, collectively illustrated as being sent over the communication link 224 from the device to the system. Typically, browsers can access, among other things, IP address, user interactions with websites (e.g., clicks, time on page), browsing history, and browser and device information. The data collection capabilities of the browser are limited to the information available.

Alternatively, apps 240 may collect more contextual information about what is happening outside the app. For instance, the app may track physical location, interactions with the device (e.g., touches and presses), the device's state (e.g., charging, locked), or the installation of other applications. Moreover, it is possible in portable devices to collect sensor data, including orientation, proximity, or microphone and camera information under certain conditions. Thus, apps have extended data collection capabilities compared to websites accessed through a browser, and all of that data can be collected over the communication link 224.

In an embodiment, the collectors 234, 244 are responsible for capturing user actions, including relevant context, and sending them to the Active Defense System 110. They integrate directly with the customer's website 230 or app 240 to capture the required information while ensuring a frictionless user experience.

Apps 240 allow broader data collection and enable more comprehensive risk assessments. Apart from that, despite differing implementation details, collectors 234, 244 operate similarly for web pages and apps. The system may dispatch the data at any time. It may happen periodically or following or preceding some action. For instance, a typical collector constructed in accordance with the present disclosure sends the data whenever the user leaves the current web page or view or accesses the next one.

An important aspect of the proposed collectors is the ability to capture user responses 232 to the applied countermeasures and share them with the Active Defense System 110, including the CADS 260. The resulting feedback loop allows the system to be dynamic and adjust to the observed responses sequentially.

In an embodiment, the Embedded Active Defense component 272, 274 (or module) included in the website 230 or app 240 interacts in real-time with the Active Defense System 110 to pull and apply applicable countermeasures for the active session.

On the one hand, this component 272, 274 communicates in real-time with the Active Defense System 110 at any moment to request countermeasures for the active sessions. Based on the risk assessment of the session, performed separately by the Intelligence component 268 previously detailed, the Active Defense System 110 may or may not return countermeasures for the session over the link 222. The communication may happen at important moments during the session, periodically, or both.

On the other hand, this 272, 274 component requires the ability to execute the actions corresponding to the countermeasures defined by the Continuous Active Defense Service 260. For instance, the countermeasure might be requesting two-factor authentication or termination of the session. Naturally, the device's context, notably the browser for web pages or the operating system for apps, limits the available actions. As mentioned in previously, the user's response to the countermeasures 232 is sent back to the Active Defense System by the collectors 234, 244.

Typically, a more comprehensive range of interventions is available to apps through the operating system's API. An illustrative example is the ability to close the application altogether, ending all the processes and cleaning all the current session data, which can be done through suitable instructions triggered as a countermeasure in response to the detected threat.

The device encryption component 226, 228 is the device counterpart of Active Defense's Encryption Component 126. It protects the communication between the device and the system by encrypting information locally before sending and decrypting all received messages. Encryption is mandatory to ensure communication safety over the internet and applies to web pages and apps.

The disclosed method and system enables interaction with the system's components and delivers security countermeasures to the user's device 220 based on the risk assessment of the session. This system may contain several components, as discussed previously.

The communications between the device and Active Defense System over the internet should be protected. The Encryption component decrypts incoming requests and encrypts outgoing responses to preserve user privacy and data integrity.

Encryption is important in building trust within the system: it ensures the security of user and customer data and the integrity of the data transmitted between the device and the Active Defense Service. Frequently, network communications use the Transport Layer Security (TLS) protocol to ensure security.

The Continuous Active Defense Service 260 is important for the Active Defense System 110. The Intelligence component 268 monitors the risk of a session in real-time, based on user-defined (costumer and/or fraud analyst) Triggers and corresponding Countermeasures. The Countermeasure Service 266 answers device requests for countermeasures 222 for the active session. The list of Affected Sessions 262 mediates the connection between the Intelligence component 268 and the Countermeasure Service 266: the first writes the affected sessions and the corresponding countermeasures for the latter to read upon request from the device.

In an embodiment, the Intelligence component 268 receives a constant flow of user actions and, under control of code executed by a processor, evaluates them against its configuration. It can also access user Reactions to previously applied countermeasures. Thus, the disclosed method and system enable dynamic analysis and countermeasures rather than static policies. If a session meets at least one of the criteria, the Intelligence component 268 places it in the Affected Sessions list.

In an embodiment, the device 220 should inquire of the system 110 for countermeasures. These requests 222 may occur at different points, including important session moments, such as visits to the login or transfer views in a banking application. They can also occur periodically, for example, every few seconds. The final goal is to enable the service to monitor the session in real-time and whenever appropriate. The Countermeasure Service 266 is responsible for receiving the requests 222, after decrypting by the encryption module 126, checking the Affected Sessions database 262 and the system's Status 252, and responding with the proper countermeasures, if they exist. The service should notify the device 220 if there are no countermeasures for the session.

As mentioned above, the service may store all interventions (Status 252) and corresponding user responses (Reactions 256). Each time a countermeasure is applied, the device may send back the observed reaction 232 to the system. Upon receiving this feedback, which is decrypted by the encryption module 126, the Intelligence component 268 may re-evaluate the session and decide whether to react and trigger 258 additional countermeasures. Hence, it enables one of the defining characteristics of the system: a dynamic feedback loop that fits digital defense's adversarial nature.

In an embodiment, the Intelligence component 268 is responsible for decision-making, under control of a suitably programmed processor. Firstly, during the configuration stage, it may receive a user-defined list of triggers 258 and corresponding countermeasures 264. Then, at inference time (that is, during an active session), it receives the signals from the device 220 and evaluates them against the user-defined configurations. Ultimately, the Intelligence component 268 aims to evaluate the risk of a session at any point in time.

The Intelligence component 268 encapsulates a variety of non-exclusive risk assessment strategies. In some applications, the CADS 260 may check a user or device blocklist. It may also consist of more complex, user-defined rules that encode expert knowledge on what constitutes risky behavior. Increasingly, it may also contain a machine learning model trained to discriminate between legitimate and suspicious behavior. After deciding on countermeasures 264, the Intelligence component 268 sends them to the Affected Sessions component 262 as described.

After countermeasures are applied, the end-user device 220 sends back the observed reaction 232. The reaction information is fed to the Intelligence component 268, triggering a new round of countermeasures whenever applicable. The Intelligence component may use any number of past reactions at any point in time, that are known to the Countermeasures Reactions storage component 256, which is detailed later on.

This component 256 allows asynchronous communication between the Intelligence component 268 and the Countermeasure Service 266. As a result, each component can scale separately. It also allows each component to write and read at its pace and therefore not interfere with or interrupt each other tasks.

A possible implementation of the Affected Sessions component 262 is a dynamic cache, where the Intelligence component 268 would write, and the Countermeasure Service 266 would have a limited time to read. Another option is using a queue, where the Intelligence component 268 would store the affected sessions 262 to be consumed by the Countermeasure Service 266. Alternatively, it may be a permanent database where the Intelligence component 268 would store the affected sessions 262, and the Countermeasure Service 266 would query for countermeasures 264.

The Countermeasure Service 266 operates on a polling model. Whenever necessary and based on user-defined configurations, the End User Device 220 calls and asks the Continuous Active Defense Service 260 for countermeasures 264 for the current session.

Upon request, the service 260 firstly queries the Affected Sessions 262 component for applicable countermeasures 264, as decided by code implementing the Intelligence component 268. Secondly, the service 260 checks the Status component 252 to understand whether they were already applied. Finally, if novel countermeasures exist, it sends the countermeasures back to the device and updates the Status accordingly.

If there are no countermeasures for the current session, the Countermeasure Service 266 notifies the device 220 that there is nothing to do at that time.

The Triggers component 258 stores the customer-defined triggers. The Intelligence component 268 refers to it to activate the corresponding countermeasures. A possible implementation is a rules database where the assigned countermeasure should be activated or deactivated for a session based on one or more conditions. For instance, the customer could define a trigger that would terminate a user's session once the level of risk surpasses a certain threshold.

The Countermeasures component 264 stores the available countermeasures as defined by the customer. Each entry contains the information required by the device 220 to execute the countermeasure. For example, the Countermeasures component could be a database containing countermeasures and parameters.

The Reactions component 256 represents storage for all user reactions to the applied countermeasures. It stores user and device information gathered in response to the prompted security action. It may be a database where each entry contains identifiers for the user, session, and countermeasure, timestamps of the countermeasure and the reaction, and any other relevant information. For example, if the countermeasure were a mouse dynamics challenge, additional information could include the mouse movement's speed.

The Administration Console component 120 enables monitoring and managing of the Continuous Active Defense System 260. The console 120 needs to cover at least the three main requirements. First, it needs to support the customer's definition of triggers provided over communication link 280 to the CADS 260 and countermeasures. Second, it needs to allow the customer to observe the current status of each session by suitable polling over communication link 282, including deployed countermeasures. Finally, it requires proper access control through the License Manager 254, including security and user management capabilities over communication link 284.

The Status component 252 stores the current status of each session so that the Continuous Active Defense Service 260 and the Administration Console 120 can consult it. It should keep track of all applied countermeasures, the triggers that originated them, and the corresponding user reactions. There is some redundancy between the Status and the Affected Sessions components, for they both store countermeasures. An important difference, however, is that the system may not apply some countermeasures. For example, maybe there were no requests from the device within a reasonable timeframe, or more recent countermeasures replaced some outdated ones.

Unlike the Affected Sessions component, the Status keeps track of the applied countermeasures (i.e., the ones effectively dispatched to the device for execution) and the observed response. It has communication links with the CADS 260, e.g. to get 286 and set 288 the status for sessions, devices.

The License Manager 254 is responsible for managing what customer users or personas can interact with what parts of the Administration Console 120. For instance, the console may require multiple access levels, as not all customer users should be able to update triggers or countermeasures (but some should). Similarly, maybe different customer users require different levels of access to the system's status.

The present disclosure has several potential implementations, namely as a remote access tool blocker.

As mentioned in Feedzai's recent Financial Crime Report [1], the most prevalent type of financial fraud is account takeover (ATO), which consists of an attacker taking over a legitimate account. In short, the attacker gains access to the user's account (e.g., by stealing the victim's login credentials) and can steal funds and information.

Many of these attacks share a typical pattern: the attacker's use of a remote access tool (RAT) to control the victim's device. Importantly, from the point of view of the service provider, the end user device 220 is the one accessing the service, using proper authentication. Hence, ATO successfully mimics legitimate usage, and it is hard to shield services from it. Additionally, there are legitimate uses of RATs to manipulate devices remotely, such as troubleshooting.

Thus, a product relevant to this use provides a possible implementation of the disclosed method and system to protect financial institutions and other digital services from account takeover fraud using RATs.

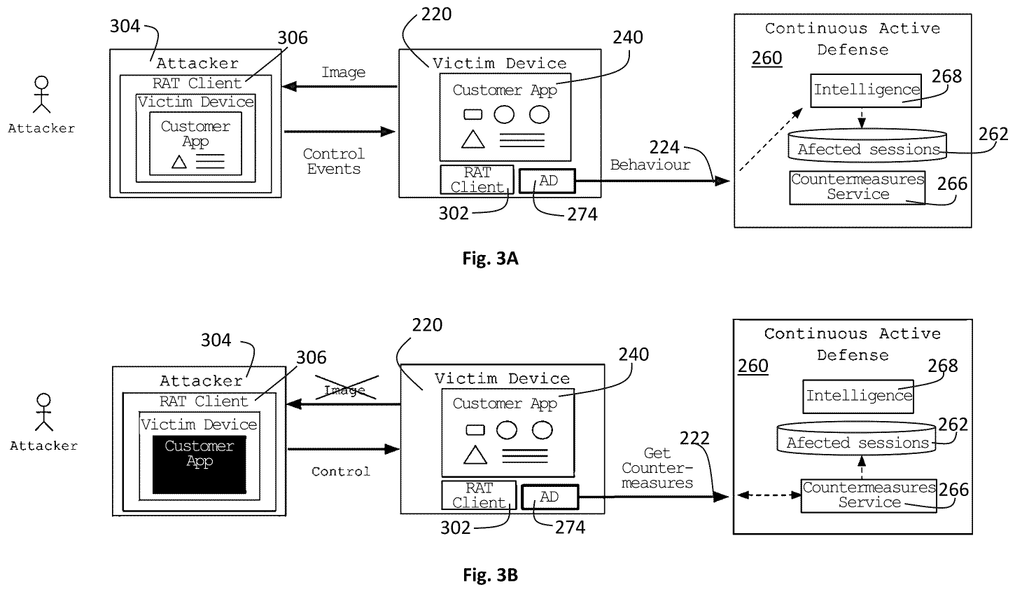

FIGS. 3A and 3B illustrate a schematic representation of an embodiment of a remote access tool protection.

FIG. 3A represents an attacker taking control of the victim's device using a RAT 302. The attacker can access the device's screen and control events remotely using a remote device 204 which is running a RAT control program 306. Therefore, the attacker can access digital services through the user's device and impersonate the user to take over, for example, a bank account.

The collectors send information 224 back to the system 260 throughout the session. The Intelligence component 268 is responsible for evaluating the risk of the session based on the received signals and continuously recommending countermeasures, when applicable. The Intelligence component 268 preferably detects the risk of account takeover and recommend adequate countermeasures as soon as possible.

In an embodiment, the Intelligence component 268 includes one or more statistical or machine learning models, or a rule-based model, to assess the risk of the session based on incoming data as described in the following paragraphs. The models can estimate the overall risk of the session. However, they can also be specialized, for example, to assess, specifically, the usage of a RAT or the risk of account takeover. Finally, the Intelligence component checks the collected signals and the model scores against the customer-defined triggers to define what countermeasures to apply.

In this case, the Intelligence component combines biometric information with other data points, such as the active view (e.g., changing personal details, transfers, or payments), transfer or payment timestamps or amounts, among other factors. Biometric information, including mouse movement, clicks, and keystrokes/typing information, is relevant, as well as touches or swipe gestures in mobile devices. For instance, the Embedded Active Defense module 274 may detect (almost) simultaneous clicks in different places with no movement. That could indicate that there may be a local user and a remote user using a RAT 304. Another illustration is that, often, there is a noticeable lag in remote sessions, for example, in keystrokes (key up and key down times), leading to different patterns leveraged by, e.g., statistical and machine learning models, as well as expert rules.

Once the Intelligence component 268 detects the risk of account takeover, it sends the appropriate countermeasures to the Affected Sessions database 262. FIG. 3B illustrates what happens when the device 220 has requested countermeasures, e.g., before authorizing a transfer. The Embedded Active Defense component 274 gets the countermeasures over the link 222 from the Active Defense System 260 and is responsible for executing them. In this case, due to the high risk of account takeover, the device immediately applies the “blacken recording” countermeasure, which turns the screen at the remote device 304 to be black to the attacker, who loses visibility of the victim's device 220.

Finally, the device 220 sends back the observed reaction over communication link 224, and the Intelligence component 268 evaluates the effectiveness of the intervention and decides on additional countermeasures. For instance, if the countermeasure did not stop the transaction's progress, a more strict countermeasure such as the total disconnection of the user may be deployed.

Some examples of countermeasures are available to the Active Defense System 260, such as blacken recording, challenge completion, device, informative, multi-factor authentication, and logout.

The Blacken recording method consists of adjusting screen capturing permission. For instance, upon meeting certain conditions, access could be entirely blocked. This countermeasure aims to protect from attacks attempting to capture the legitimate user's screen, most notably Remote Access Tool (RAT) 302 attacks. In the event of launching the countermeasure while an attacker is capturing the screen, the attack would stop, for the attacker would lose visibility. Importantly, there is no impact on the end-user, who may be able to continue to use the device without friction.

The challenge completion countermeasure entails a challenge that the end-user should complete. This countermeasure aims to collect data in a controlled scenario. One possible challenge is to prompt the user to write the text displayed on an image to collect biometrical information from the keystrokes over a controlled text. With this information, the Intelligence component could compare this reaction with previous reactions and search for possible anomalies, and in that case, serve another more restricting countermeasure. One may also request the user to move the mouse or the device according to a particular pattern. In the meantime, the system may gather the movements and sending reactions 224 back to the Active Defense System 260 to process the information and try to detect anomalies.

The device characterization countermeasure is one of the countermeasures known to the countermeasures database 264, and when utilized it executes an action on the device. Its main advantage is subtleness. For example, the system may run a particular computation and measure the device's performance. Once this information about the device is collected, it is sent as a reaction back to the Active Defense System to perform further analysis and apply further countermeasures if needed. If appropriately performed, these countermeasures should not cause significant usability degradation on the device.

The informative countermeasure objective is one of the countermeasures known to the countermeasures database 264, and when utilized it communicates something, e.g., information or instructions, to the user. The service could report a message to the device user, for instance. The method of communication includes but is not limited to pop-up messages. In some situations, a lesser invasive countermeasure is due, and an informative solution is adequate. The Active Defense System may employ more severe countermeasures based on the observed outcome.

A more invasive countermeasure would be a Multi-Factor Authentication (MFA) trigger, another countermeasure known to the countermeasures database 264. The method implemented by this countermeasure consists of forcing a cross-device challenge for the end-user to execute. The service could report and activate a multi-factor authentication challenge to the device user and lock the ensuing usage of the service prior to the challenge completion. The challenge should be a holistic validation cross-device, such as a password introduction on a different, known device.

The logout countermeasure is another countermeasure known to the countermeasures database 264, and it consists of disconnecting from the service. The method restricts access and navigation. More severe countermeasures, such as permanently blocking particular actions or subsequent access, may follow.

In relation to the actors who interact with the Active Defense System and their motivations there are end users, customers, and fraud analysts.

The end users refers to the actual person interested in the usage of the Customer Service. For instance, this person could be the user of a banking website or application. In this case, the interaction of this actor with the Active Defense System is indirect. The Collectors explained in this disclosure are the ones responsible of capturing the needed information to offer the Active Defense, without the end user noticing this collection.

The customer refers to the actor interested in providing the Active Defense to each of their end users. A customer could be any company, such as a financial institution like a bank, or any other interested party, such as merchants. The main interaction required by the Customer is to establish the condition of when and how each countermeasure is triggered. The Customer may also be interested in checking the current status of the system, knowing what is the status of each session and which countermeasures have been applied and which were the reactions to these countermeasures. The Customer interactions are handled by the Administration Console.

The Fraud Analysts are the experts on fraud who collaborate with the Customer. For that, they need to understand and analyze the suspicious sessions. Therefore, they need access to the status of each of these sessions. They achieve this goal by accessing to the Administration Console, where they may query the status and investigate each of the sessions and the active countermeasures, as well as the reactions to these countermeasures.

Opposingly to access control systems which primarily focus on the moment of the access, the disclosed method and system provide continuous monitoring with opportune countermeasure challenging and thus consider a comprehensive, client-defined range of events of interest.

Flow diagrams of particular embodiments of the presently disclosed methods are depicted in figures. The flow diagrams illustrate the functional information one of ordinary skill in the art requires to perform said methods required in accordance with the present disclosure.

It will be appreciated by those of ordinary skill in the art that unless otherwise indicated herein, the particular sequence of steps described is illustrative only and can be varied without departing from the disclosure. Thus, unless otherwise stated the steps described are so unordered meaning that, when possible, the steps can be performed in any convenient or desirable order.

It is to be appreciated that certain embodiments of the disclosure as described herein may be incorporated as code (e.g., a software algorithm or program) residing in firmware and/or on computer useable medium having control logic for enabling execution on a computer system having a hardware computer processor, such as any of the servers described herein. Such a computer system typically includes hardware memory storage devices configured to provide output from execution of the code which configures a hardware processor in accordance with the execution. The code can be arranged as firmware or software, and can be organized as a set of modules, including the various modules and algorithms described herein, such as discrete code modules, function calls, procedure calls or objects in an object-oriented programming environment. If implemented using modules, the code can comprise a single module or a plurality of modules that operate in cooperation with one another to configure the machine in which it is executed to perform the associated functions, as described herein.

The subject matter described above is provided by way of illustration only and should not be construed as limiting. Various combinations, alternatives, modifications and changes can be made to the subject matter described herein without following the precise contours of the exemplary embodiments and applications illustrated and described herein, which could be devised by those of ordinary skill in the art without departing from the true spirit and scope of the invention encompassed by the present disclosure. The present disclosure is intended to embrace all such combinations, alternatives, modifications and variances and the invention is defined by the set of recitations in the following claims and by structures and functions or steps which are equivalent to these recitations.

The term “comprising” whenever used in this document is intended to indicate the presence of stated features, integers, steps, components, but not to preclude the presence or addition of one or more other features, integers, steps, components, or groups thereof.

The disclosure should not be seen in any way restricted to the embodiments described and a person with ordinary skill in the art will foresee many possibilities to modifications thereof. The above-described embodiments are combinable.

The following claims further set out particular embodiments of the disclosure.

### REFERENCES

[1] Feedzai. Feedzai Q2 2022 Financial Crime Report: “The RiskOps Age”. https://feedzai.com/resource/feedzai-q2-2022-financial-crime-report/, 2022.
[2] Aisha Abdallah, Mohd Aizaini Maarof, and Anazida Zainal. Fraud detection system: A survey. Journal of Network and Computer Applications, 68:90-113, 2016.
[3] Antesar M Shabut, Khin T Lwin, and M Alamgir Hossain. Cyber attacks, countermeasures, and protection schemes—a state of the art survey. In 2016 10th International Conference on Software, Knowledge, Information Management & Applications (SKIMA), pages 37-44. IEEE, 2016.
[4] R McGraw. Risk-adaptable access control (radac). In Privilege (Access) Management Workshop. NIST-National Institute of Standards and Technology-Information Technology Laboratory, volume 25, pages 55-58, 2009.
[5] Pau-Chen Cheng, Pankaj Rohatgi, Claudia Keser, Paul A Karger, Grant M Wagner, and Angela Schuett Reninger. Fuzzy multi-level security: An experiment on quantified risk-adaptive access control. In 2007 IEEE Symposium on Security and Privacy (SP'07), pages 222-230. IEEE, 2007.
[6] Savith Kandala, Ravi Sandhu, and Venkata Bhamidipati. An attribute based framework for risk-adaptive access control models. In 2011 Sixth International Conference on Availability, Reliability and Security, pages 236-241. IEEE, 2011.
[7] Riaz Ahmed Shaikh, Kamel Adi, and Luigi Logrippo. Dynamic risk-based decision methods for access control systems. computers & security, 31(4):447-464, 2012.
[8] Weili Han, Chen Sun, Chenguang Shen, Chang Lei, and Sean Shen. Dynamic combination of authentication factors based on quantified risk and benefit. Security and Communication Networks, 7(2):385-396, 2014.
[9] Issa Traore, Isaac Woungang, Mohammad S Obaidat, Youssef Nakkabi, and Iris Lai. Combining mouse and keystroke dynamics biometrics for risk-based authentication in web environments. In 2012 fourth international conference on digital home, pages 138-145. IEEE, 2012.
[10] Christopher Bailey, David W Chadwick, and Rogerio De Lemos. Self-adaptive authorization framework for policy based rbac/abac models. In 2011 IEEE Ninth International Conference on Dependable, Autonomic and Secure Computing, pages 37-44. IEEE, 2011.
[11] Stephan Wiefling, Tanvi Patil, Markus Du\ddot{ } rmuth, and Luigi Lo Iacono. Evaluation of riskbased re-authentication methods. In IFIP International Conference on ICT Systems Security and Privacy Protection, pages 280-294. Springer, 2020.
[12] Daniel D'iaz-L'opez, Gin'es D'olera-Tormo, F'elix G'omez-M'armol, and Gregorio Mart'inez-P'erez. Dynamic counter-measures for risk-based access control systems: An evolutive approach. Future Generation Computer Systems, 55:321-335, 2016.
[13] Miguel Calvo and Marta Beltr'an. A model for risk-based adaptive security controls. Computers & Security, page 102612, 2022.
[14] Stephan Wiefling, Luigi Lo Iacono, and Markus Du\ddot{ } rmuth. Is this really you? an empirical study on risk-based authentication applied in the wild. In IFIP International Conference on ICT Systems Security and Privacy Protection, pages 134-148. Springer, 2019.
[15] Hervé Debar, Marc Dacier, and Andreas Wespi. Towards a taxonomy of intrusion-detection systems. Computer networks, 31(8):805-822, 1999.
[16] Laurens Sion, Dimitri Van Landuyt, Koen Yskout, and Wouter Joosen. Sparta: Security & privacy architecture through risk-driven threat assessment. In 2018 IEEE International Conference on Software Architecture Companion (ICSA-C), pages 89-92. IEEE, 2018.
[17] Rabie A Ramadan, Bassam W Aboshosha, Jalawi Sulaiman Alshudukhi, Abdullah J Alzahrani, Ayman El-Sayed, and Mohamed M Dessouky. Cybersecurity and countermeasures at the time of pandemic. Journal of Advanced Transportation, 2021, 2021.
[18] A Jesudoss and N Subramaniam. A survey on authentication attacks and countermeasures in a distributed environment. Indian Journal of Computer Science and Engineering (IJCSE), 5(2):71-77, 2014.
[19] Periwinkle Doerfler, Kurt Thomas, Maija Marincenko, Juri Ranieri, Yu Jiang, Angelika Moscicki, and Damon McCoy. Evaluating login challenges as a defense against account takeover. In The World Wide Web Conference, pages 372-382, 2019.
[20] Guma Ali, Mussa Ally Dida, and Anael Elikana Sam. Two-factor authentication scheme for mobile money: A review of threat models and countermeasures. Future Internet, 12(10):160, 2020.
[21] Zulfikar Ramzan. Phishing attacks and countermeasures. Handbook of information and communication security, pages 433-448, 2010.
[22] David James Wayne Teeple and Christopher A. Dodunski. Systems and methods for tracking, analyzing and mitigating security threats in networks via a network traffic analysis platform. US20160308898A1, 2016.
[23] David B. Amsler, Nick Allen, Sarah Messer, and Trent Healy. Automated internet threat detection and mitigation system and associated methods. U.S. Pat. No. 9,258,321B2, 2013.
[24] Tommy Stiansen, Samuel M. Glines, and Sheldon H. Foss, Jr. Systems and methods for dynamic protection from electronic attacks. U.S. Pat. No. 9,160,764B2, 2012.
[25] Ihab Shraim and Mark Shull. Advanced responses to online fraud. US20070192853A1, 2004.
[26] Daniel Ahles and Bruce Dragt. Check transmission information notification system for fraud prevention. US20090307119A1, 2008.
[27] Brian D. Laughlin, John William Glatfelter, and William David Kelsey. Mobile security countermeasures. EP3428819A1, 2017.
[28] Prasanna Ganapathi Basavapatna, Deepakeshwaran Kolingivadi, and Sven Schrecker. Userdefined countermeasures. US20130096980A1, 2011.
[29] Siying Yang. Reliable selection of security countermeasures. U.S. Pat. No. 10,333,924B2, 2014.
[30] Gustavo Gonzalez Granadillo and Herv'e Debar. Selection of countermeasures against cyber attacks. U.S. Ser. No. 10/419,474B2, 2014.
[31] Kevin Patrick Mahaffey, Timothy Micheal Wyatt, Brian James Buck, John Gunther Hering, Amit Gupta and Alex Cameron Abey. Distributed monitoring, evaluation, and response for multiple devices. U.S. Pat. No. 9,753,796B2, 2013.

1. A method for securing an online client-server session between a client device and a server device by application of at least a countermeasure comprising a predetermined session-security challenge-response pair, the method comprising the steps of:
the server device collecting client behavior pattern during the online session;
the server device marking the online session as an affected session according to a pre-agreed client-server protocol;
the client device requesting a client-initiated countermeasure according to the pre-agreed client-server protocol;
the server device responding with an indication of a particular countermeasure to be carried out by the client device;
the client device carrying out the indicated particular countermeasure and sending to the server device a reaction to the countermeasure; and
the server device verifying the client reaction to the countermeasure, and if verified, marking the online session as non-affected.

2. The method according to claim 1, further comprising the steps of:
if the client reaction to a countermeasure is not verified, the client device requesting an additional client-initiated countermeasure according to the pre-agreed client-server protocol;
the server device responding with an indication of a particular additional countermeasure to be carried out by the client device;
the client device carrying out the indicated particular additional countermeasure and sending to the server device a reaction to the additional countermeasure; and
the server device verifying the client reaction to the additional countermeasure, and if verified, marking the online session as non-affected.

3. The method according to claim 1, wherein the pre-agreed client-server protocol comprises triggering the steps of marking and requesting a countermeasure when:
a particular client behaviour pattern occurs during the online session; and/or
a periodic time period occurs during the online session.

4. The method according to claim 3, wherein the client behaviour pattern includes at least one selection from the group consisting of: an estimated security risk of illicit account takeover above a predetermined threshold; a particular device characteristic or characteristics; a particular user journey; a particular user interaction; a particular set of user interactions; and a lack of a particular user interaction.

5. The method according to claim 1, wherein the client device requesting a client-initiated countermeasure according to the pre-agreed client-server protocol is synchronized with predetermined online session events comprising login of the online session or window focus loss of the online session, or combination thereof.

6. The method according to claim 1, wherein the particular countermeasure to be carried out by the client device is selected from a list consisting of:
blackening screen capture by adjusting screen capture permissions;
completing a challenge response, in particular comprising text-completion challenge, mouse movement challenge and/or image classification challenge;
carrying out a two-factor authentication challenge; and
logging out the online session.

7. The method according to claim 1, wherein the online client-server session is pre-authenticated.

8. The method according to claim 1, wherein the server device marks the online session as an affected session according to a pre-agreed client-server protocol, without sending an indication of the affected status to the client.

9. The method according to claim 1, wherein the online session is a client-server web session and the client device runs a web browser arranged to carry out the client device side of the method.

10. The method according to claim 9, wherein the server-device is arranged to serve a web page comprising computer program instructions that, when run on the client device, cause it to carry out the client device side of the method.

11. The method according to claim 1, wherein the online session is a client-server application session and the client device runs an application comprising an application library arranged to carry out the client device side of the method.

12. The method according to claim 1, wherein an indication of sessions marked as affected are stored in a dynamic cache with a time-limited read period, or in a queue, or in a database.

13. The method according to claim 12, further comprising providing a countermeasure service for the server device to respond with an indication of a particular countermeasure or countermeasures to be carried out by the client device, wherein said countermeasure service is a client-initiated polling service.

14. The method according to claim 1, wherein a session marked as affected has a corresponding countermeasure or countermeasures stored in a countermeasure database.

15. The method according to claim 14, wherein the countermeasure or countermeasures available for a session marked as affected are determined by one or more triggers at the server device when the online session is marked as an affected session according to the pre-agreed client-server protocol.

16. The method according to claim 15, wherein one or more triggers are contained in a rule database where, for each rule, a corresponding countermeasure is enabled or disabled according to a predetermined condition or conditions.

17. The method according to claim 1, wherein communications between server device and client device are encrypted.

18. A non-transitory computer-readable medium comprising computer program instructions for securing an online client-server session between a client device and a server device, which when executed by a processor, cause the processor to carry out the method of claim 1.

19. A system comprising a client device and a server device, for securing an online client-server session between the client device and the server device by application of at least a countermeasure comprising a predetermined session-security challenge-response pair, the system being arranged to carry out the steps of:
the server device collecting client behavior pattern during the online session;
the server device marking the online session as an affected session according to a pre-agreed client-server protocol;
the client device requesting a client-initiated countermeasure according to the pre-agreed client-server protocol;
the server device responding with an indication of a particular countermeasure to be carried out by the client device;
the client device carrying out the indicated particular countermeasure and sending to the server device a reaction to the countermeasure; and
the server device verifying the client reaction to the countermeasure, and if verified, marking the online session as non-affected.
